(19) United States
(12) Patent Application Publication
(10) Pub. No.: US 2003/0231350 A1
(43) Pub. Date: Dec. 18, 2003

(54) Method and apparatus for image forming capable of correcting variations in image density

(76) Inventor: Naoko Yamagishi, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/346,092

(22) Filed: Jan. 17, 2003

(30) Foreign Application Priority Data
Jan. 17, 2002 (JP) 2002-008610

(51) Int. Cl. H04N 1/405; H04N 1/409

(52) U.S. Cl. 358/3.06; 358/3.26; 358/406

(57) ABSTRACT

An image forming apparatus including an image carrying member, a test pattern generator, a physical quantity measuring mechanism, and an image noise characteristic detector. The image carrying member carries a toner image through an electrophotographic process and the test pattern generator generates a predetermined test pattern on the image carrying member. The physical quantity measuring mechanism measures a physical quantity distribution with respect to the predetermined test pattern, and the image noise characteristic detector detects plural types of image noise in the predetermined test pattern based on the physical quantity distribution with respect to the predetermined test pattern. An image forming method is described which detects plural type of image noise in the predetermined test pattern.

### BACKGROUND OF THE INVENTION

1. Field of the Invention

The present invention relates to a method and apparatus for image forming, and more particularly to a method and apparatus for image forming capable of correcting variation in image density based on calculation of plural types of image characteristics.

2. Discussion of the Background

An image forming apparatus such as a digital copying machine and a printer using an electrophotographic process typically produces an image having variations in image density in a sub-scanning direction, referred to as a banding, when an image carrying member is unevenly rotated. Major causes of the banding are vibrations relating to the rotations of the image carrying member and other movements of the mechanism associated, and manufacturing variations of components used in the image forming apparatus.

Various countermeasures, such as to increase accuracy of the components and to protect resonance, are generally taken to minimize the effects of the above-mentioned causes in the image forming apparatus. Japanese Laid-Open Patent Application Publication No. 08-115038 describes an image forming apparatus including an encoder for detecting a rotational status of an image carrying member to monitor variations in speed of the image carrying member. Based on this detection, the speed of the image carrying member is controlled to a substantially constant speed. Japanese Laid-Open Patent Application Publication No. 2000-122508 describes an image forming apparatus which forms an image pattern having equally spaced line segments on a transfer belt and detects the image pattern with an optical sensor. Based on the detection result, the image forming apparatus calculates periodic variations in rotation of a motor for driving a photosensitive member or the transfer belt and corrects for the rotation speed.

These techniques, however, are not directly detecting and correcting density variations in an image and therefore the corrections cannot be made in a sufficiently accurate manner.

### SUMMARY OF THE INVENTION

In view of the foregoing, it is an object of the present invention to provide a novel image forming apparatus which corrects variations in image density to output a superior quality image.

Another object of the present invention is to provide a novel image forming method which corrects variations in image density to output a superior quality image.

To achieve these and other objects, in one example, a novel image forming apparatus includes an image carrying member, a test pattern generator, a physical quantity measuring mechanism, and an image noise characteristic detector. The image carrying member is configured to carry a toner image through an electrophotographic process. The test pattern generator is configured to generate a predetermined test pattern on the image carrying member. The physical quantity measuring mechanism is configured to measure a physical quantity distribution with respect to the predetermined test pattern. The image noise characteristic detector is configured to detect plural types of image noise in the predetermined test pattern based on the physical quantity distribution with respect to the predetermined test pattern.

The plural types of image noise may include a sub-scanning banding and a main-scanning banding, or a banding and a graininess.

The predetermined test pattern may include a plurality of halftone images different from each other, and the image forming apparatus may further include a process selector configured to select a halftone process based on the plural types of image noise detected from the predetermined test pattern by the image noise characteristic detector.

The predetermined test pattern may include a plurality of test pattern images having different halftone levels in response to a plurality of input levels. Each of the test pattern images include a plurality of halftone images different from each other. In addition, the image forming apparatus may further include a process selector configured to select a halftone process based on the plural types of image noise detected from the predetermined test pattern by the image noise characteristic detector.

Further, to achieve the above-mentioned objects, in one example, another novel image forming apparatus includes an image carrying member, a test pattern generator, a physical quantity measuring mechanism, an image characteristic calculator, and an image area judging mechanism, and a process selector. The image carrying member is configured to carry a toner image through an electrophotographic process. The test pattern generator is configured to generate a predetermined test pattern on the image carrying member. The physical quantity measuring mechanism is configured to measure a physical quantity distribution with respect to the predetermined test pattern. The image characteristic calculator is configured to calculate image characteristics based on the physical quantity distribution measured by the physical quantity measuring mechanism. The image area judging mechanism is configured to judge image areas of original image data. The process selector is configured to select an appropriate image processing operation to be performed relative to the original image data in accordance with the image characteristics calculated by the image characteristic calculator and a result of judgment performed by the image area judging mechanism.

The image characteristics calculated by the image characteristic calculator may include plural types of image noise with respect to the predetermined test pattern.

The appropriate image processing operation may include a plurality of halftone processes different from each other.

The image area judging mechanism may judge a text image area and a halftone image area in input image data.

The predetermined test pattern may include a plurality of halftone images different from each other, and the process selector may select an appropriate halftone process from among the plurality of halftone processes based on the image characteristics calculated by the image characteristic calculator with respect to the predetermined test pattern and perform the selected appropriate halftone process relative to an image area of the original image data judged as a halftone image area by the image area judging mechanism and an edge enhancing process to an image area of the original image data judged as a text image area by the image area judging mechanism.

The predetermined test pattern may include a plurality of test pattern images having different halftone levels in response to a plurality of input levels, and the process selector may select an appropriate halftone process from among the plurality of halftone processes based on the image characteristics calculated by the image characteristic calculator with respect to the predetermined test pattern and perform the selected appropriate halftone process relative to an image area of the original image data judged as a halftone image area by the image area judging mechanism and an edge enhancing process to an image area of the original image data judged as a text image area by the image area judging mechanism.

The image characteristics calculated by the image characteristic calculator may include an image sharpness with respect to the predetermined test pattern, and the process selector may select an appropriate edge enhancing process based on the image sharpness calculated by the image characteristic calculator with respect to the predetermined test pattern to perform the appropriate edge enhancing process to an image area of the original image data judged as a text image area by the image area judging mechanism.

Further, to achieve the above-mentioned objects, in one example, a novel image forming method includes the steps of generating, measuring, and detecting. The generating step generates a predetermined test pattern through an electrophotographic process. The measuring step measures a physical quantity distribution with respect to the predetermined test pattern. The detecting step detects plural types of image noise in the predetermined test pattern based on the physical quantity distribution with respect to the predetermined test pattern.

The plural types of image noise may include a sub-scanning banding and a main-scanning banding, or a banding and a graininess.

The predetermined test pattern may include a plurality of halftone images different from each other. In addition, the image forming method may further include a step of selecting a halftone process based on the plural types of image noise detected from the predetermined test pattern by the detecting step.

The predetermined test pattern may include a plurality of test pattern images having different halftone levels in response to a plurality of input levels, each of the test pattern images including a plurality of halftone images different from each other. In addition, the image forming method may further include a step of selecting a halftone process based on the plural types of image noise detected from the predetermined test pattern by the detecting step.

Further, to achieve the above-mentioned objects, in one example, another novel image forming method includes the steps of generating, measuring, calculating, judging, and selecting. The generating step generates a predetermined test pattern through an electrophotographic process. The measuring step measures a physical quantity distribution with respect to the predetermined test pattern. The calculating step calculates image characteristics based on the physical quantity distribution measured by the physical quantity measuring step. The judging step judges image areas of original image data. The selecting step selects an appropriate image processing operation to be performed relative to the original image data in accordance with the image characteristics calculated by the calculating step and a result of judgment performed by the judging step.

The image characteristics calculated by the calculating step may include plural types of image noise with respect to the predetermined test pattern.

The appropriate image processing operation may include a plurality of halftone processes different from each other.

The judging step may judge a text image area and a halftone image area in input image data.

The predetermined test pattern may include a plurality of halftone images different from each other, and the selecting step may select an appropriate halftone process from among the plurality of halftone processes based on the image characteristics calculated by the calculating step with respect to the predetermined test pattern and perform the selected appropriate halftone process relative to an image area of the original image data judged as a halftone image area by the judging step and an edge enhancing process to an image area of the original image data judged as a text image area by the judging step. The predetermined test pattern may include a plurality of test pattern images having different halftone levels in response to a plurality of input levels, and the selecting step may select an appropriate halftone process from among the plurality of halftone processes based on the image characteristics calculated by the calculating step with respect to the predetermined test pattern and perform the selected appropriate halftone process relative to an image area of the original image data judged as a halftone image area by the judging step and an edge enhancing process to an image area of the original image data judged as a text image area by the judging step.

The image characteristics calculated by the calculating step may include an image sharpness with respect to the predetermined test pattern, and the selecting step may select an appropriate edge enhancing process based on the image sharpness calculated by the calculating step with respect to the predetermined test pattern so as to perform the appropriate edge enhancing process to an image area of the original image data judged as a text image area by the judging step.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a block diagram of an image forming system according to a preferred embodiment of the present invention;

FIG. 2 is a flowchart of an exemplary procedure of an image forming operation performed by the image forming apparatus of FIG. 1;

FIGS. 3A and 3B are illustrations for explaining an exemplary optical mechanism for detecting a test pattern formed on an image carrying member of the image forming apparatus of FIG. 1;

FIG. 4 is a flowchart of an exemplary procedure of an image noise calculation performed by an image noise calculator of the image forming apparatus of FIG. 1;

FIGS. 5A-5C are graphs explaining methods for selecting an appropriate halftone process;

FIG. 6 is a flowchart of another exemplary procedure of the image forming operation performed by the image forming apparatus of FIG. 1;

FIG. 7 is an illustration of input levels associated with the halftone processes;

FIG. 8 is a flowchart of another exemplary procedure of the image noise calculation performed by the image noise calculator of the image forming apparatus of FIG. 1;

FIGS. 9A and 9B are graphs demonstrating relationships between banding values and average lightness values and between graininess values and the average lightness values, in association with the halftone processes;

FIG. 10 is a flowchart of an exemplary halftone process selection performed by a process selector of the image forming apparatus of FIG. 1;

FIGS. 11A and 11B are a graph and an enlargement in part, demonstrating relationships between the banding and graininess values and input levels in association with the halftone processes;

FIG. 12 is a block diagram of an image forming apparatus according to another preferred embodiment of the present invention;

FIG. 13 is a block diagram for explaining functions and a data flow of the image forming apparatus of FIG. 12;

FIG. 14 is an illustration of a matrix used by an image area judgment;

FIG. 15 is a flowchart of an exemplary procedure of the image forming operation performed by the image forming apparatus of FIG. 12;

FIG. 16 is a flowchart of another exemplary procedure of the image forming operation performed by the image forming apparatus of FIG. 12;

FIG. 17 is a flowchart of further another exemplary procedure of the image forming operation performed by the image forming apparatus of FIG. 12;

FIG. 18 is an illustration of a ladder pattern for an edge enhancement process, included in the test pattern; and

FIG. 19 is a time chart showing a rectangular wave signal obtained based on density distribution data.

### DETAILED DESCRIPTION OF PREFERRED EMBODIMENTS

In describing preferred embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner.

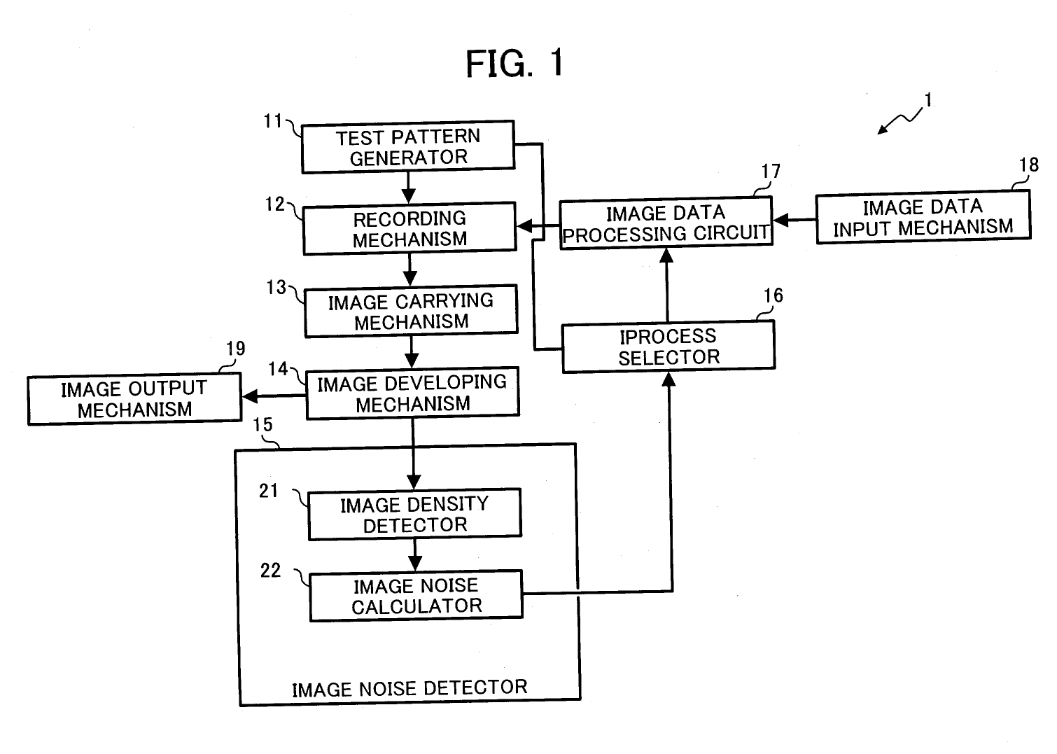

Referring now to the drawings, wherein like reference numerals designate identical or corresponding parts throughout the several views, particularly to FIG. 1, an image forming apparatus 1 according to a preferred embodiment of the present invention is explained. The image forming apparatus 1 of FIG. 1 according to a preferred embodiment of the present invention efficiently reduces image noise which is generated in an image formed in an image forming process of the image forming apparatus 1. An image noise generally means a random noise caused by an image output mechanism of an image forming apparatus, a periodical noise caused by a mechanical or electrical cause or an image processing, and a sporadic noise. However, image noise also refers to causes of image quality deteriorations including background noise, an uneven gloss of image, and so forth. The above-mentioned random noise is generally referred to as a problem of graininess, and the periodical and sporadic noises are generally referred to as a problem of banding.

As shown in FIG. 1, the image forming apparatus 1 includes a test pattern generator 11, a recording mechanism 12, an image carrying mechanism 13, an image developing mechanism 14, an image noise detector 15, a process selector 16, an image data processing circuit 17, an image data input mechanism 18, and an image output mechanism 19.

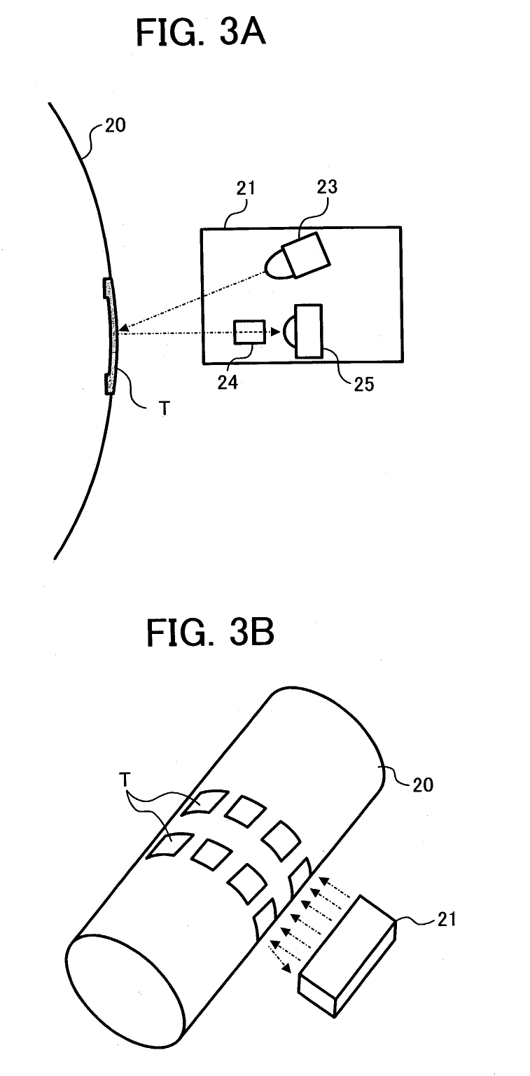

The test pattern generator 11 generates a test pattern signal and sends it to the recording mechanism 12. The recording mechanism 12 forms a latent image on the image carrying mechanism 13 according to the test pattern signal sent from the test pattern generator 11. The image carrying mechanism 13 includes a rotary image carrying member 20 (see FIG. 3A) for carrying the latent image. The image developing mechanism 14 develops the latent image formed on and carried by the image carrying mechanism 13 with toner into a toner image. The image noise detector 15 includes an image density detector 21 measuring an image density distribution of the test pattern and an image noise calculator 22 calculating data of an image noise. The calculated image noise data is sent to the process selector 16 which is connected to the test pattern generator 11 to reference an input level of the test pattern input.

The process selector 16 appropriately selects a halftone process from among a plurality of halftone processes based on the calculated image noise data sent from the image noise detector 15, and stores the halftone process selected in a memory (not shown) included in the process selector 16. The image data processing circuit 17 refers to the memory of the process selector 16 and performs the selected halftone process relative to image data input by the image data input mechanism 18.

The image data processed through the selected halftone process by the image data processing circuit 17 is sent to the recording mechanism 12 and is subjected to an electrophotographic image forming procedure with the recording mechanism 12, the image carrying mechanism 13, and the image developing mechanism 14. A resultant image formed through the electrophotographic image forming procedure is output through the image output mechanism 19.

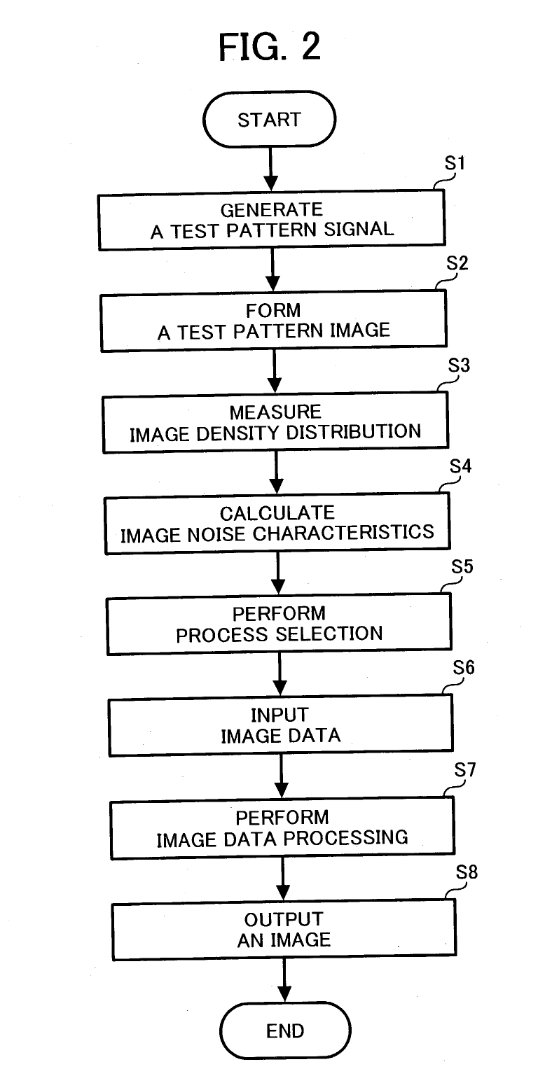

Referring to FIG. 2, an exemplary procedure of an image forming operation of the image forming apparatus 1 is explained. As one example, this embodiment uses a plurality of selectable halftone processes P1, P2, P3, P4, and P5. In Step S1 of FIG. 2, the test pattern generator 11 generates and sends a test pattern signal to the recording mechanism 12. The test pattern signal represents a test pattern image including a plurality of test patches having gradually varied halftone levels.

Then, in Step S2, the recording mechanism 12 forms a latent image on the image carrying mechanism 13 with a laser light beam modulated in accordance with the test pattern signal and subsequently the image development mechanism 14 develops the latent image into a toner image of the test patches.

Then, in Step S3, the image density detector 21 of the image noise detector 15 measures the density of the test patches formed on the image carrying mechanism 13 and outputs density distribution data. The density distribution data is the data representing a distribution of the physical characteristic quantity with respect to the test patches formed.

Then, in Step S4, the image noise detector 22 calculates first and second density deviations and sends them to the process selector 16. The first density deviation is the density deviation of the test patches in a rotational direction of the rotary image carrying member 20 and represents one of many image noise characteristics with respect to the test patches. The first density deviation may also be referred to as a sub-scanning banding. Likewise, the second density deviation is the density deviation of the test patches in a direction orthogonal to the rotation direction of the rotary image carrying member 20 and represents another one of image noise characteristics with respect to the test patches. The second density deviation may also be referred to as a main-scanning banding.

Then, in Step S5, the process selector 16 performs the process selection to appropriately select a halftone process from among the plurality of halftone processes P1-P5 based on the first and second deviation data, and stores the selected halftone process in the memory thereof. Then, in Step S6, the image data input mechanism 18 inputs image data to the image data processing circuit 17. After that, in Step S7, the image data processing circuit 17 references the memory of the process selector 16 and performs the selected halftone process relative to the input image data. Subsequently, the image data processed through the halftone process is sent to the recording mechanism 12. Then, in Step S8, a toner image is formed according to the image data with the recording mechanism 12, the image carrying mechanism 13, and the image developing mechanism 14, and then the formed toner image is output through the image output mechanism 19.

In this embodiment, a set of the sub-scanning and main-scanning bandings are detected and used as examples of physical characteristics with respect to the test patches formed. However, the present invention is not limited to these characteristics and may detect and use other physical characteristics of the test patches, such as a set of the sub-scanning banding and a graininess of the test patches, for example. It may also be possible to detect and use other physical characteristics representing the image of the test patches for evaluating an image in a quantitative manner. Further, it may be possible to detect and use a set of any three or more quantitative factors of physical characteristics representing the image of the test patches.

In addition, the image carrying mechanism 13 may include a photosensitive member. Alternatively, when the image forming apparatus 1 has a structure including an intermediate transfer mechanism disposed between a photosensitive member for carrying a toner image and a transfer member for transferring the toner image onto a recording medium, the image carrying mechanism 13 may include the intermediate image transfer member.

As for the time of measuring the density distribution with respect to the test patches, it may also be possible to measure the density distribution of the toner image after the process of transferring the toner image onto a recording sheet or fixing the toner image on the recording sheet after the transfer process.

With the above-described structure, the image forming apparatus 1 can detect plural types of image noises contained in the formed test patches and, based on the detection, it can select an appropriate halftone process to be performed relative to the input image data. As a result, the image forming apparatus 1 can reduce the plural types of image noises at the same time.

FIGS. 3A and 3B show a mechanism for measuring the density distribution of the test patches in the main-scanning and sub-scanning directions. In FIG. 3A, the image density detector 21 includes a light source 23, a lens 24, and a CCD (charged-couple device) line sensor 25. The light source 23 emits a light beam in a direction to irradiate a toner image T of the test patches, and the light beam reflected by the toner image T of the test patches is focused on the CCD line sensor 25 by the lens 24. Thereby, the light beam is properly sensed by the CCD line sensor 25. In a test pattern detection, the toner images T of the test patches are formed around the rotary image carrying member 20, as shown in FIG. 3B. The image density detector 21 performs this operation in a continuous manner with the rotary image carrying member 20 rotating during a time period of the test pattern detection so that optical information in two dimensions, that is in the main-scanning and sub-scanning directions, can be obtained with respect to the toner image of the test patches. Based on the optical information obtained, the image density detector 21 generates density distribution data with respect to the toner image of the test patches in the main-direction and sub-directions, and transfers the data to the image noise calculator 22 which calculated the first and second density deviations, as described above.

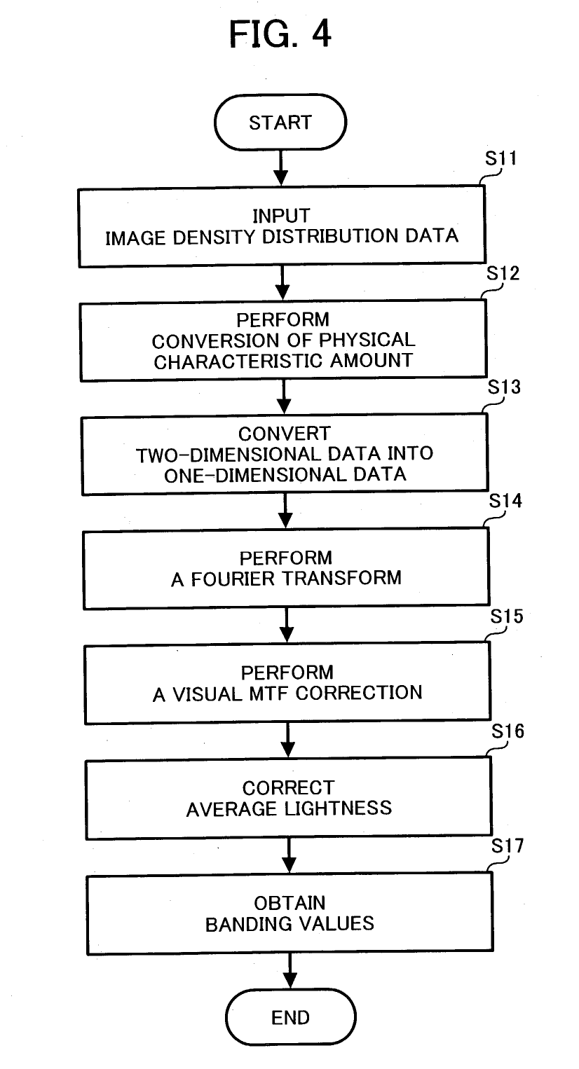

FIG. 4 shows an exemplary procedure of the calculation for the first and second density deviations, that is the sub-scanning and main-scanning bandings, respectively, which are performed by the image noise calculator 22 in Step S4 of FIG. 2. This procedure of FIG. 4 is based on a known method proposed by Japanese Laid-Open Patent Application Publication No. 2000-004313, for example. In Step S11 of FIG. 4, the image density detector 21 inputs the two-dimensional density distribution data to the image noise calculator 22. Then, in Step S12, the image noise calculator 22 performs a conversion of a physical characteristic quantity, that is, it converts the two-dimensional density distribution data into two-dimensional lightness distribution data. Then, in Step S13, the two-dimensional lightness distribution data is converted into single-dimensional lightness distribution data. That is, to obtain the sub-scanning banding amount, the two-dimensional lightness distribution data is averaged in the main scanning direction. To obtain the main-scanning banding amount, the two-dimensional lightness distribution data is averaged in the sub-scanning direction.

Then, in Step S14, the image noise calculator 22 performs a Fourier transform to convert the single-dimensional lightness distribution data of the sub-scanning and main-scanning bandings into the respective data of spatial frequencies. After that, in Step S15, the image noise calculator 22 performs a visual characteristic correction by multiplying the respective spatial frequencies with a visual MTF (modulation transfer function) as a visual spatial frequency characteristic. Subsequently, in Step S16, the image noise calculator 22 performs a correction based on an average lightness with respect to the respective spatial frequencies. Then, in Step S17, the image noise calculator 22 calculates the sub-scanning and main-scanning bandings based on the respectively corrected spatial frequencies. An exemplary formula for calculating the sub-scanning and main-scanning bandings is shown below;

(B1,B2)=(2,372ΔL*+0.331)exp(0.0144L*)exp(−0.208u)×[1−exp {(0.0176L*−0.176)u}]−0.0133,

wherein B1 and B2 are the sub-scanning and main-scanning bandings, respectively, ΔL* is an amplitude of the lightness at each frequency, ΔL* is the average lightness, and u is the spatial frequency in units of c/deg.

An exemplary procedure of the operation performed by the process selector 16 is explained. The process selector 16 first performs a conversion of the one-dimensional data into no-dimensional data to compare the amounts of the sub-scanning and main-scanning bandings directly to each other. In this example, the process selector 16 uses ratios of the one-dimensional data to a reference value. For example, a reference value for the sub-scanning banding is set to 0.21 and a reference value for the main-scanning banding is also set to 0.21. These reference values may be changed to reflect user preferences on image quality. Table 1 below shows the no-dimensional exemplary data with respect to the sub-scanning banding (B1) and the main-scanning banding (B2) in accordance with the halftone processes P1-P5.

TABLE 1

| Process | B1 | B2 |
|---|---|---|
| P1 | 3.09 | 2.55 |
| P2 | 2.50 | 1.83 |
| P3 | 2.81 | 3.67 |
| P4 | 1.62 | 2.39 |
| P5 | 2.49 | 2.33 |

Here, an exemplary procedure of the halftone process selection by the process selector 16 is explained. The process selector 16 performs a first comparison with respect to the no-dimensional data of B1 and B2 in each halftone process of Table 1, and then a second comparison of the greater ones to each other, obtained as a result of the first comparison. After the second comparison, the process selector 16 selects the smallest value found in the second comparison. In the case of Table 1, the process selector 16 selects the halftone process P1 as the most appropriate halftone process according to the procedure explained above.

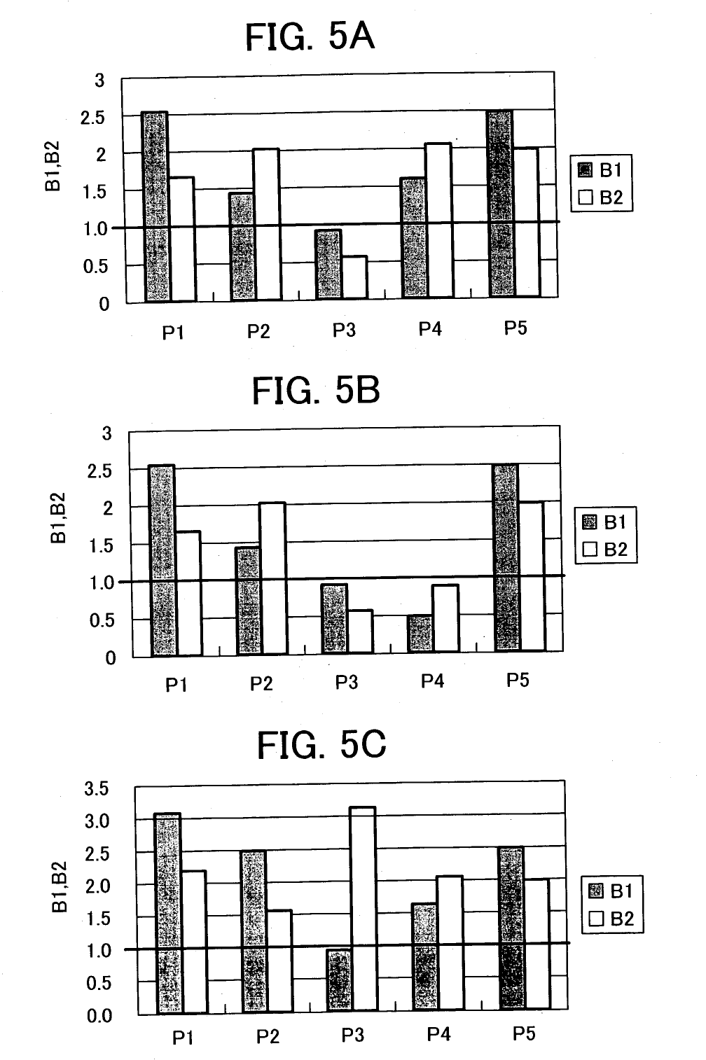

FIGS. 5A-5C show different cases of the banding data to which exemplary alternative halftone process selection procedures may be needed. In FIG. 5A only one halftone process (i.e., the halftone process P3) has the sub-scanning and main-scanning banding values smaller than the reference value and other halftone processes (i.e., the halftone processes P1, P2, P4, and P5) have at least one of the sub-scanning and main-scanning banding values greater than the reference value. In FIG. 5A, the process selector 16 selects the halftone process P3 as the most appropriate halftone process.

FIG. 5B shows a case in which more than two halftone processes (i.e., the halftone processes P3 and P4) have sub-scanning and main-scanning banding values smaller than the reference value. In this case, the sub-scanning and main-scanning banding values in each of the halftone processes P3 and P4 are summed, as shown in Table 2 below. Then, the process selector 16 selects the halftone process having the value smaller than that of the other halftone process. As shown in Table 2, the halftone process P4 is selected as the most appropriate halftone process in this case.

TABLE 2

| Process | B1 | B2 | B1 + B2 |
|---|---|---|---|
| P3 | 0.937 | 0.585 | 1.522 |
| P4 | 0.502 | 0.871 | 1.373 |

FIG. 5C is a case in which every halftone process has at least one of the sub-scanning and main-scanning banding values greater than the reference value. In this case, the sub-scanning and main-scanning banding values in each of the halftone processes P1-P5 are summed, as shown in Table 3 below. Then, the process selector 16 selects the halftone process having the smallest sum value. As shown in Table 3, the halftone process P4 is selected as the most appropriate halftone process in this case.

TABLE 3

| Process | B1 | B2 | B1 + B2 |
|---|---|---|---|
| P1 | 3.09 | 2.18 | 5.27 |
| P2 | 2.50 | 1.57 | 4.07 |
| P3 | 0.952 | 3.14 | 4.09 |
| P4 | 1.62 | 2.05 | 3.67 |
| P5 | 2.49 | 2.00 | 4.49 |

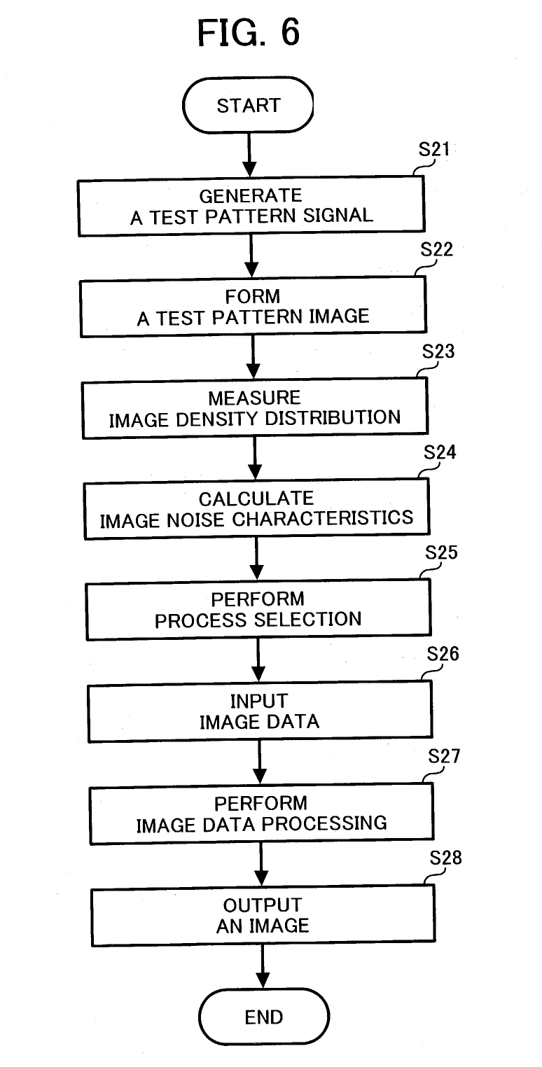

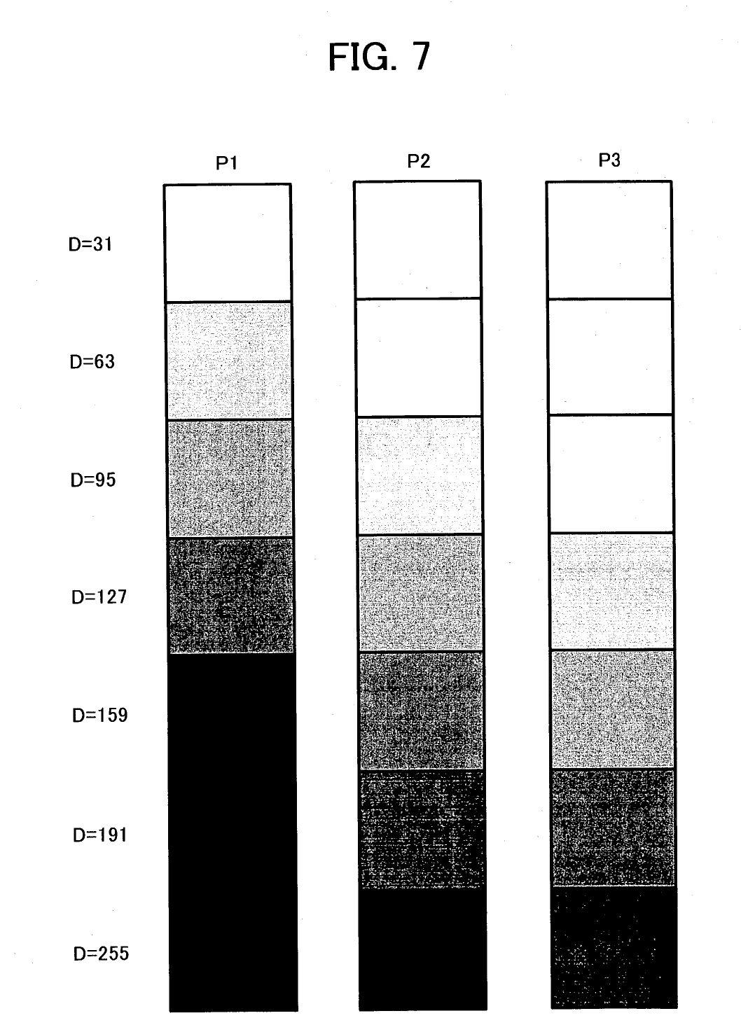

Next, another procedure of the image forming operation performed by the image forming apparatus 1 is explained with reference to FIG. 6. As one example, this procedure uses input levels of 31, 63, 95, 127, 159, 191, and 255 and the selectable halftone processes P1, P2, and P3, as shown in FIG. 7. In addition, the procedure of FIG. 6 applies the banding data and the graininess data to the halftone selection in a way as explained later.

In Step S21 of FIG. 6, the test pattern generator 11 sequentially generates and sends a test pattern signal to the recording mechanism 12. The test pattern signal represents a plurality of test patterns expressing different halftone test patch sets in accordance with the above-mentioned input levels. The test pattern generator 11 includes a memory for previously storing the test patterns.

Then, in Step S22, the recording mechanism 12 forms a latent image on the image carrying mechanism 13 with a laser light beam modulated in accordance with the test pattern signal and, subsequently, the image development mechanism 14 develops the latent image into a toner image of the test patterns.

Then, in Step S23, the image density detector 21 of the image noise detector 15 measures the density of the test patterns formed on the image carrying mechanism 13 and outputs density distribution data of the respective test patterns. The density distribution data is the data representing a distribution of the physical characteristic quantity with respect to the test patterns formed in accordance with the input levels.

Then, in Step S24, the image noise detector 22 calculates the banding and the graininess for each of the test patterns as the image noise characteristics, based on the density distribution data transferred from the image density detector 21, and sends them to the process selector 16.

Then, in Step S25, the process selector 16 performs the halftone process selection to appropriately select a halftone process from among the plurality of halftone processes P1-P3, based on the banding and the graininess of each of the test patterns transferred from the image noise detector 15, and stores the selected halftone process in the memory thereof. Then, in Step S26, the image data input mechanism 18 inputs image data to the image data processing circuit 17. After that, in Step S27, the image data processing circuit 17 references the memory of the process selector 16 and performs the selected halftone process relative to the input image data. Subsequently, the image data processed through the most appropriate halftone process is sent to the recording mechanism 12. Then, in Step S28, a toner image is formed according to the image data via the recording mechanism 12, the image carrying mechanism 13, and the image developing mechanism 14. After that, the formed toner image is output through the image output mechanism 19.

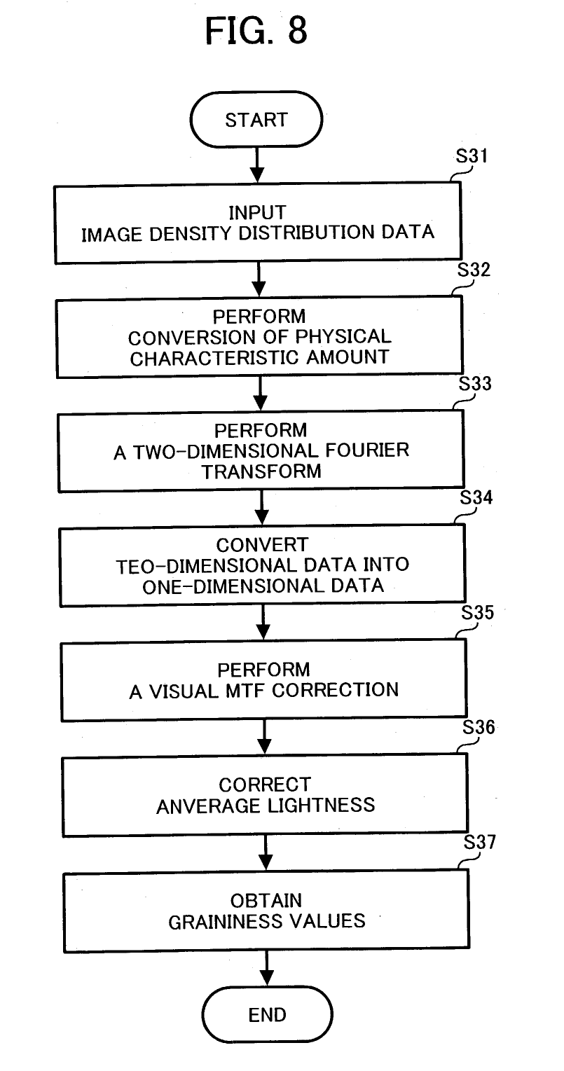

Here, an exemplary procedure of the calculation of the image noise characteristics performed by the image noise calculator 22 in Step S24 of FIG. 6 is explained with reference to FIG. 8. The description below focuses on a calculation of the graininess of the test patches, but does not provide a description regarding the banding since the banding data calculation is referred to in the description with reference to FIG. 4. The procedure of the calculation of the graininess with respect to the test patches is prepared based on a known procedure reported in “An image noise evaluation of halftone color image,” 189-192 of “Japan Hardcopy '96.”

In Step S31 of FIG. 8, the image density detector 21 inputs the density distribution data in the two dimensions to the image noise calculator 22. Then, the image noise calculator 22 performs the conversion of the physical characteristic quantity to convert the density distribution data into lightness distribution data in Step S32. Subsequently, in Step S33, the image noise calculator 22 performs the two-dimensional Fourier transform to obtain spatial frequencies. Then, the spatial frequencies are converted into single-dimensional data in Step S34. After that, in Step S35, a visual characteristic correction is performed by a multiplication of the visual modulation transform function (MTF) used as the spatial frequency characteristic to the single-dimensional data obtained in Step S34. Then, in Step S36, a correction with an average lightness is performed so that the graininess is obtained in Step S37.

An exemplary formula for calculating the graininess of the test patches in the above-described procedure is shown below;

(graininess)=h(L*)_{pL}·×L*(u)×VTF(u)df+C,

wherein h(L*) is a function with a variable of the average lightness, ΔL*(u) is a frequency element in a lightness noise, VTF(u) is a visual spatial frequency element relative to the lightness, and pL* and C are constants.

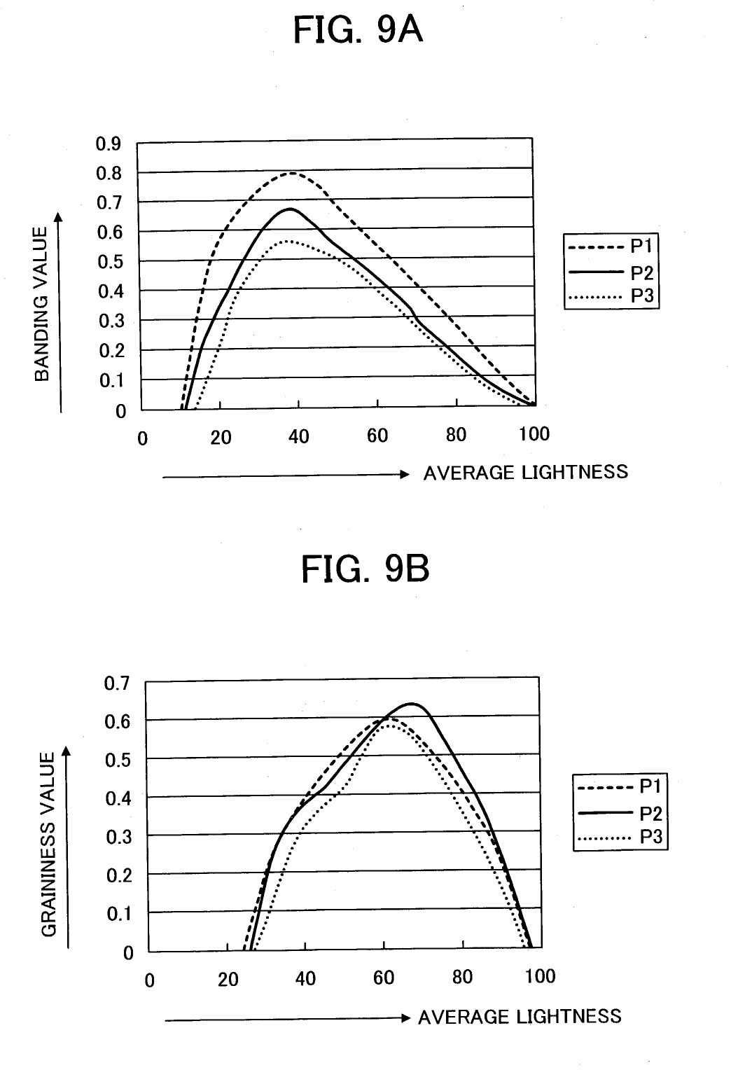

Here, an exemplary procedure of the halftone process selection performed by the process selector 16 in Step S25 of FIG. 6 is explained with reference to FIGS. 9A, 9B, 10, 11A and 11B. This exemplary procedure of the halftone process selection as set forth below is made based on the following results, shown in FIGS. 9A and 9B, of an experiment conducted by the inventor of the present invention.

FIG. 9A shows the calculation results of the bandings generated in an image which has been subjected to the respective halftone processes P1-P3, wherein the horizontal axis is the average lightness. As shown in FIG. 9A, the banding has a peak around an average lightness of 40 in each of the cases with the respective halftone processes P1-P3.

Likewise, FIG. 9B shows the calculation results of the graininess appearing in an image which has been subjected to the respective halftone processes P1-P3, wherein the horizontal axis is the average lightness. As shown in FIG. 9B, the graininess has a peak around an average lightness of 70 in each case with the respective halftone processes of P1-P3.

As shown in FIGS. 9A and 9B, the experiments underscored that the maximum average lightness of the banding and that of the graininess were different from each other. The banding had the maximum average lightness in a relatively low lightness side and the graininess had the one in a relatively high lightness side. It is possible to change the horizontal axes of the graphs of FIGS. 9A and 9B to an input level, while maintaining the above-mentioned resultant relationship found between the maximum average lightness of the banding and the graininess. For example, when an input level of 0 is applied as the lowest lightness and an input level of 255 as the highest lightness, the banding has the maximum value in a relatively low input level side and the graininess has the maximum in a relatively high input level side. This result is used as one example in the embodiment explained above.

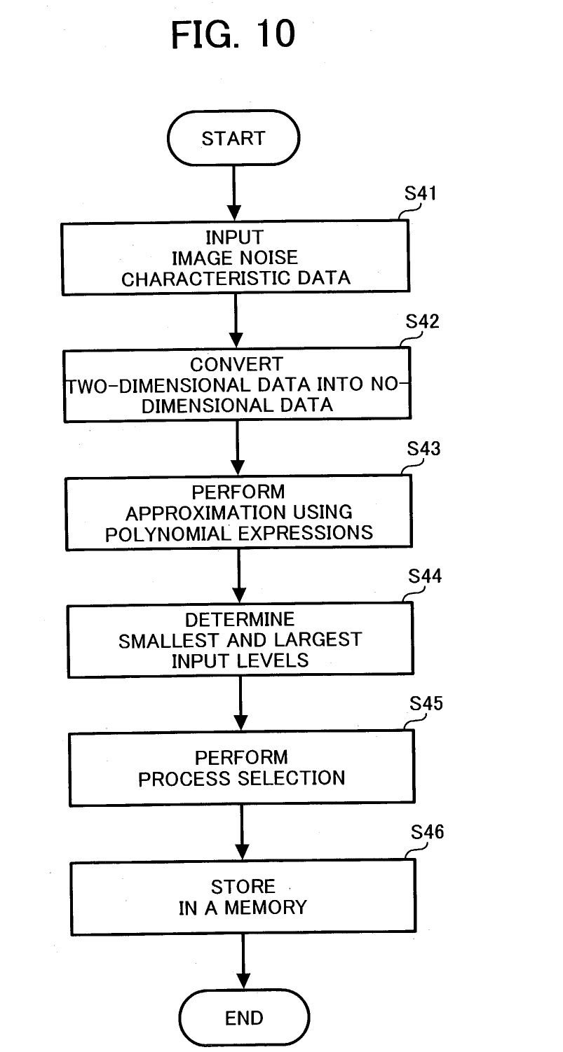

FIG. 10 shows the exemplary procedure of the halftone process selection performed by the process selector 16 in Step S25 of FIG. 6. In Step 41 of FIG. 10, the banding data and the graininess data are input to the process selector 16 by the image noise calculator 22. Then, in Step S42, the process selector 16 performs a conversion of the one-dimensional data into no-dimensional data to compare the amounts of the banding data and the graininess data directly to each other. In this example, the process selector 16 uses ratios of the one-dimensional data as a reference value. For example, a reference value for the banding is set to 0.21 and a reference value for the graininess is set to 0.15. These reference values may be changed to reflect user preferences on image quality.

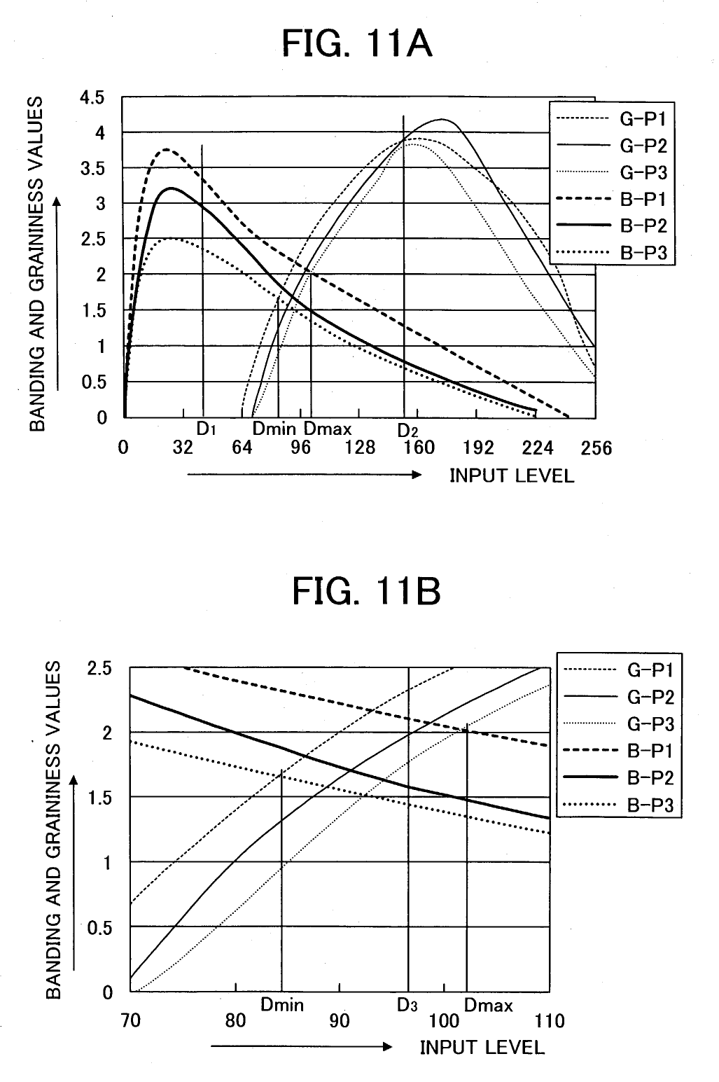

Then, in Step S43, the process selector 16 plots the ratios of the banding data and of the graininess data to respective correspond reference values for each of the halftone processes P1-P3, as shown in FIG. 11A, and then performs an approximation with a polynomial expression relative to the plotted ratios for each of the halftone processes P1-P3. In FIG. 11A, the horizontal axis is the input level. In this process, the process selector 16 uses the input levels stored in the memory of the test pattern generator 11.

Then, in Step S44, the process selector 16 calculates every possible intersection point of all the lines drawn by the polynomial expressions, as shown in FIG. 11A, and obtains a smallest input level Dₘᵢₙ and a greatest input level Dₘₐₓ in the intersection points.

Then, in Step S45, the process selector 16 performs a calculation using the smallest input level Dₘᵢₙ and the greatest input level Dₘₐₓ, and selects an appropriate halftone process from among the halftone processes P1-P3 based on the calculation results.

As shown in FIG. 11A, the banding value is greater, or more conspicuous, than the graininess value with any one of the halftone processes P1-P3 in a region where the input level is smaller than the smallest input level Dₘᵢₙ. On the contrary, however, the graininess value is greater, or more conspicuous, than the banding value with any one of the halftone processes P1-P3 in a region where the input level is greater than the smallest input level Dₘₐₓ.

Therefore, the process selector 16 has a prioritization criterion in that the image noise characteristic data is determined as in a range where the banding is needed to be reduced when the input level is smaller than the smallest input level. Also, the process in a range where the graininess is needed to be reduced when the input level is greater than the greatest input level.

According to these prioritization criteria, the process selector 16 suitably selects one of the halftone processes P1-P3 which reduces the banding to the smallest value, relative to an input level D₁ in a range smaller than the smallest input level Dₘᵢₙ (i.e., D₁<Dₘᵢₙ). When an input level D₂ is greater than the greatest input level Dₘₐₓ (i.e., D₂>Dₘₐₓ), the process selector 16 suitably selects one of the halftone processes P1-P3 which reduces the graininess to the smallest value. The halftone process thus suitably selected is stored in the memory of the process selector 16.

When an input level D₃ is between the smallest and greatest input levels (i.e., Dₘᵢₙ<D₃<Dₘₐₓ), the process selector 16 selects an appropriate halftone process for the input level D₃ in the following manner. The process selector 16 obtains the banding value and the graininess value using the graph of FIG. 11A. A part of FIG. 11A most relevant to this operation is shown in an enlarged form of FIG. 11B. Then, the process selector 16 sums the banding and graininess values in each of the halftone processes P1-P3, as shown in Table 4 below, wherein B is the banding value and G is the graininess value. Then, the process selector 16 selects the halftone process having the smallest sum value as an appropriate halftone process for the input level D₃. As shown in Table 4, the halftone process P3 is selected as the most appropriate halftone process in this case.

TABLE 4

| Process | B | G | B + G |
|---|---|---|---|
| P1 | 2.13 | 2.34 | 4.47 |
| P2 | 1.61 | 1.99 | 3.60 |
| P3 | 1.43 | 1.78 | 3.21 |

As an alternative to the calculations as set forth, the process selector 16 may also use any one of the procedures described with reference to FIGS. 2 and 5A-5C to select the most appropriate halftone process.

After the selection of the most appropriate halftone process, in Step S46, the process selector 16 stores the selected process in the memory thereof.

In this embodiment, the banding and the graininess are detected and used as examples of physical characteristics with respect to the test patches formed. However, the present invention is not limited to that detection and may detect and use other physical characteristics of the test patches having the largest values in average lightness ranges different from each other.

As for the time of measuring the density distribution with respect to the test patches, it may also be possible to measure the density distribution of the toner image after the process of transferring the toner image onto a recording sheet or fixing the toner image on the recording sheet after the transfer process.

Using the above-described procedure of FIG. 6, the image forming apparatus 1 can detect plural types of image noises contained in the formed test patches and, based on the detection, it can select an appropriate halftone process to be performed relative to the input image data. As a result, it becomes possible for the image forming apparatus 1 to reduce the plural types of image noises at the same time.

As described above, vibrations are the major causes of the image noise in relation to the rotational mechanism of the rotary image carrying mechanism 13 and the variations of the components generated during the manufacturing process, and they are substantially apt to vary with time. Therefore, the above-described halftone process selection according to the preferred embodiments of the present invention is preferably performed from time to time on a periodical-time or random-time basis. Preferably, the halftone process selection is performed during a time out of the actual print time. More preferably, the halftone process selection is performed during an initial operation at a power-on time, for example. Thereby, the image forming apparatus 1 automatically performs the image noise correction with the most appropriate halftone process in the image data processing to obtain an image constantly of a superior quality.

It is also possible to perform the halftone process selection by forming the test pattern in a non-image forming area of the rotary image carrying member 20. Thus, the image forming apparatus 1 can perform the halftone process selection even during the actual print time and can perform the image noise correction with the most appropriate halftone process in the image data processing to obtain an image constantly of a superior quality. Forming the test pattern in a non-image forming area of the rotary image carrying member 20 helps to avoid an extra load to the rotary image carrying member 20 so that the rotary image carrying member 20 lasts longer.

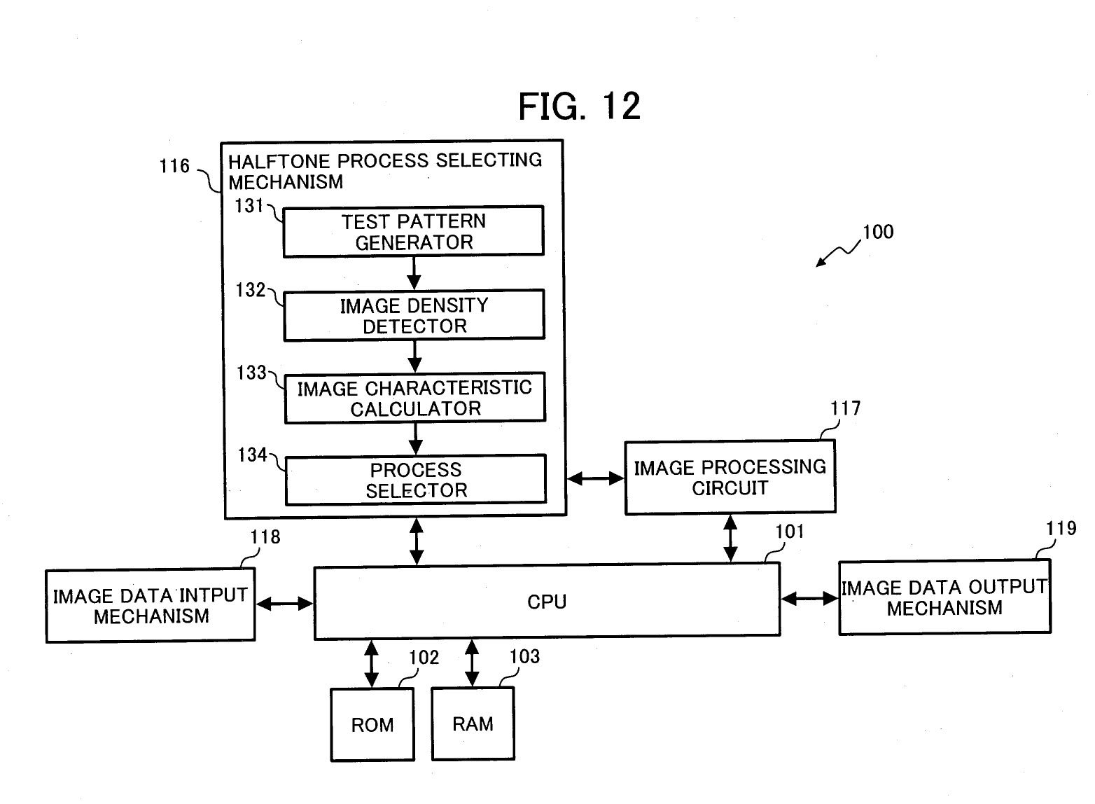

Next, an image forming apparatus 100 according to another preferred embodiment of the present invention is explained with reference to FIG. 12. As shown in FIG. 12, the image forming apparatus 100 includes a CPU (central processing unit) 101, a process selection mechanism 116, an image data processing circuit 117, an image data input mechanism 118, and an image output mechanism 119. The image forming apparatus 100 further includes a ROM (read only memory) 102 for storing various programs and a RAM (random access memory) 103 including a memory space for serving as a working memory space.

The CPU 101 controls all the operations of the image forming apparatus 100. The image data input mechanism 118 inputs image data to the image data processing mechanism 117 via the CPU 101. The image data input to the image data processing mechanism 117 is digital data having an 8-bit digital value per pixel converted from analog data read by a CCD (charge-coupled device) or the like. The image data processing mechanism 117 performs various kinds of image data processing operations, for example, a gamma correction and an image area judgment relative to the image data received. The image data processing operations also includes the appropriate halftone correction selected by the process selection mechanism 116. The process selection mechanism 116 includes a test pattern generator 131, an image density detector 132, an image characteristic calculator 133, and a process selector 134. The image output mechanism 119 processes the data received from the image data processing mechanism 117, and outputs an image on a recording sheet through the electrophotographic sequential operations including the latent image forming, the image development, the image transfer, and the image fixing.

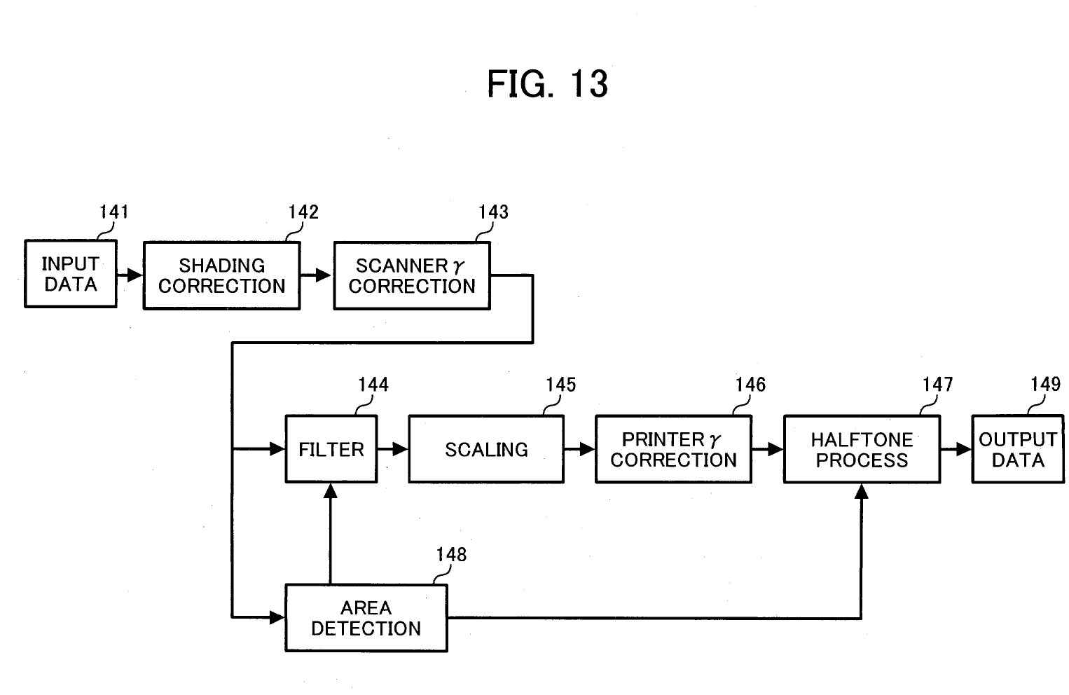

FIG. 13 shows an exemplary procedure of the digital image data processing operations performed by the image data processing mechanism 117. In this procedure, an input data 141 is subjected to a shading correction 142 to become free from errors caused by variations of the light source, the optical system, the reading elements, and so on. Then, the input data 141 is subjected to a scanner gamma correction 143.

The input data 141 is then further subjected to a filter 144 for enhancing edges of an image, smoothing, etc. Next, a scaling 145 changes a speed of a scanner carriage and calculates an interpolation relative to the input data 141 to scale an image of the input data 141. Then, the input data 141 is subjected to a printer gamma correction 146. Then, a halftone process 147 performs a halftone process such as a dither or an error diffusion by quantizing the input data 141 in a form of output data 149 having a number of bits corresponding to a number of output bits used by the printer mechanism.

The handling of the digital image data explained above in this procedure of FIG. 13 is merely an example, and there are many available alternatives. The above procedure being explained includes an image area judgment 148 for judging types of an image area and sending the judging result to the filter 144 and the-halftone process 147.

The input data 141 is subjected to the image area judgment 148 for judging an image area by using a density characteristic of the input data 141, after the scanner gamma correction 143. As one example, a halftone image, such as a photograph, is judged if it is a photographic image or not by using a general tendency that a photographic image extensively includes halftone image areas and an image other than a photographic image, such as a text image and a dot image, includes not many halftone image areas.

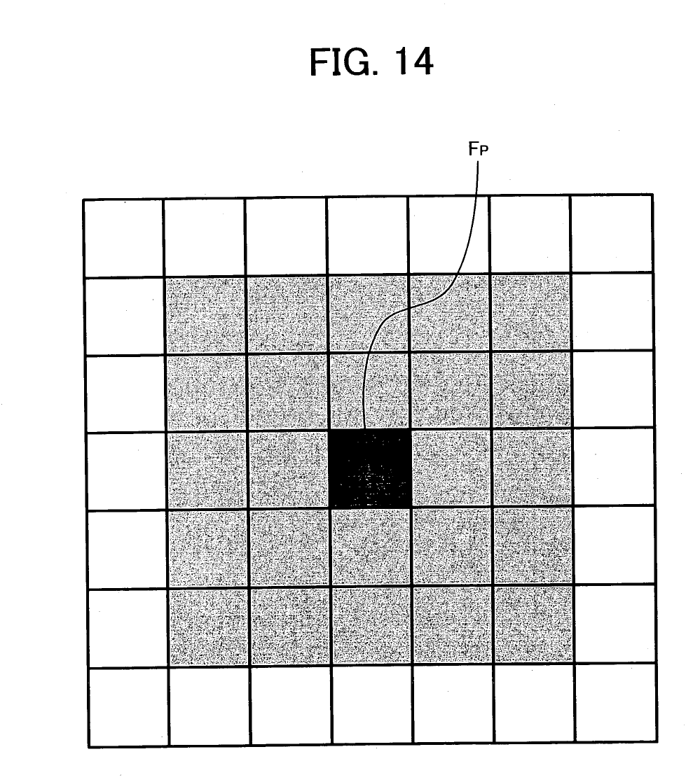

More specifically, this judgment judges an image area of the image data in units of an area having 5×5 pixels with a focus pixel Fp at the center thereof, as shown in FIG. 14. When every pixel of the unit area has a halftone density, the area is judged as a photographic image area and every other case is judged as an image area other than a photographic area. On the other hand, a text image area is judged with a pattern matching using continuity of black pixels (i.e., a high density) and white pixels (i.e., a low density).

In this way, an image area judgment is performed based on a histogram of image densities obtained as the judgment results with respect to the text image area and the halftone image area.

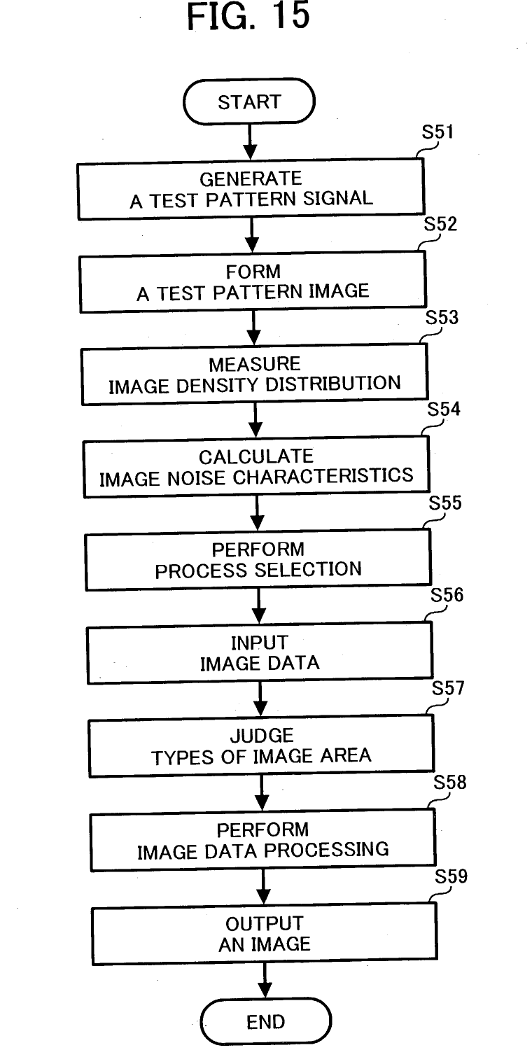

Referring to FIG. 15, an exemplary procedure of the image forming operation performed by the image forming apparatus 100 of FIG. 12 is now explained. This exemplary procedure allows the image forming apparatus 100 to select an appropriate halftone process in accordance with the two-dimensional banding data calculated based on the density distribution data with respect to an image formed using the test pattern. The image forming apparatus 100 is further allowed by the procedure to find a halftone image area of input image data and to perform the appropriate halftone process relative to image data in the halftone image area found in the input image data. As one example, the image forming apparatus 100 is provided with the selectable halftone processes P1, P2, P3, P4, and P5, for example.

In Step S51 of FIG. 15, the test pattern generator 131 of the process selecting mechanism 116 generates a test pattern signal and sends it to a recording mechanism (not shown). The test pattern signal represents a test pattern image including a plurality of test patches having different halftone levels. Then, in Step S52, an image of the test pattern is formed through the electrophotographic procedure. That is, the recording mechanism forms a latent image on an image carrying member (not shown) in accordance with a laser light beam modulated with the test pattern signal, and an image development mechanism (not shown) develops a toner image of the test patches. The image carrying member of the image forming apparatus 100 is one similar to the rotary image carrying member 20 of FIG. 3A, for example.

Then, in Step S53, the image density detector 132 of the process selecting mechanism 116 measures the density of the test pattern formed on the image carrying member, and outputs density distribution data of the test pattern to the image characteristic calculator 133. The density distribution data represents a distribution of the physical characteristic quantity with respect to the test pattern. The image density detector 132 includes optical components similar to those of the image density detector 21 of FIG. 3A, for example.

Then, in Step S54, the image characteristic calculator 133 calculates the sub-scanning banding and the main-scanning banding as image characteristics with respect to the test pattern, based on the density distribution data transferred from the image density detector 132, and sends the calculation results to the process selector 134.

Then, in Step S55, the process selector 134 performs the process selection to select an appropriate halftone process from among the plurality of halftone processes P1-P5 based on the sub-scanning and main-scanning banding data transferred from the image characteristic calculator 133. The selected halftone process is stored in the memory of the process selector 134.

The calculation of the image characteristic calculator 133 and the selection of the process selector 134 are performed in operations similar to those described for the image forming apparatus 1.

A set of the sub-scanning banding data and the main-scanning banding data may be substituted by a set of the sub-scanning banding data and the graininess data, or other quantitative factors of image quality. Also, it may be possible to apply a set of any three or more quantitative factors of physical characteristics with respect to the image of the test patches. The halftone processes P1-P5 may be based on the dither with different number of lines, or the error diffusion, or a blue noise method. That is, any halftone process with any number of selections may be applied.

In addition, the above-mentioned image carrying member may include a photosensitive member. As an alternative, if the image forming apparatus 100 has a structure including an intermediate transfer mechanism disposed between a photosensitive member for carrying a toner image and a transfer member for transferring the toner image onto a recording medium, the image carrying mechanism may include the intermediate image transfer member.

In addition, it may be possible to perform the measurement of the density distribution with respect to the toner image after the process of transferring the toner image onto a recording sheet or fixing the toner image on the recording sheet after the transfer process.

Then, in Step S56, the image data input mechanism 118 inputs image data to the image data processing circuit 117 via the CPU 101. After that, in Step S57, the image processing circuit 117 performs the image area judgment to judge a text image area requiring an edge enhancement and a halftone image area requiring an image noise reduction. Then, in Step S58, the image data processing circuit 117 refers the memory of the process selector 134 and performs the selected appropriate halftone process relative to the image area judged as a halftone image area. Also, an image area judged as a text image area is subjected to the edge enhancing process by the image processing circuit 117. After that, the image data is sent to the recording mechanism.

The edge enhancing process may use a Laplacian filter method or an unsharp mask (USM) method, or other common edge enhancing techniques.

Then, in Step S59, a toner image is formed according to the image data with the recording mechanism, the image carrying member, and the image developing mechanism. Then, the toner image is output through the image output mechanism.

In this way, the image forming apparatus 100 performs the halftone process selection based on the image noise of the two-dimensional banding data and the image area judgment relative to the input image data, and executes the edge enhancing process to the text image area and the selected appropriate halftone process to the halftone image area in the input image data. Thereby, the image forming apparatus 100 can reduce plural types of image noise at the same time while maintaining a sharpness in the text image area.

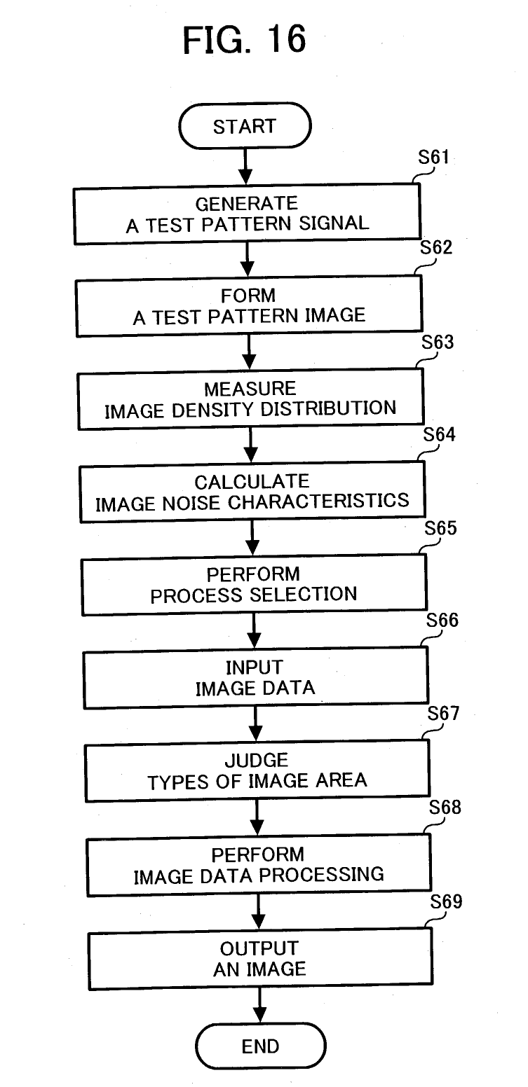

Next, another exemplary procedure of the image forming operation performed by the image forming apparatus 100 is explained with reference to FIG. 16. This exemplary procedure allows the image forming apparatus 100 to select an appropriate halftone process in accordance with a data set of the banding and the graininess calculated based on the density distribution data with respect to an image formed using a plurality of test patterns. The image forming apparatus 100 is further allowed by the procedure to find a halftone image area of input image data and to perform the appropriate halftone process relative to image data in the halftone image area found in the input image data. As one example, the image forming apparatus 100 is provided with the data of input levels 31, 63, 95, 127, 159, 191, and 255, for example, and the selectable halftone processes P1, P2, and P3, for example, which are shown in FIG. 7.

In Step S61 of FIG. 16, the test pattern generator 131 of the process selecting mechanism 116 generates a test pattern signal and sends it to the recording mechanism. The test pattern signal represents a plurality of test patterns expressing different halftone test patch sets in accordance with the above-mentioned different input levels. Then, in Step S62, an image of the test patterns is formed through the electrophotographic procedure. That is, the recording mechanism forms a latent image on the image carrying member with a laser light beam modulated with the test pattern signal, and the image development mechanism develops a toner image of the test patterns.

Then, in Step S63, the image density detector 132 measures the densities of the test patterns formed on the image carrying member, and outputs density distribution data of the test patterns to the image characteristic calculator 133. The density distribution data represents a distribution of the physical characteristic quantity with respect to the test patterns formed in accordance with the input levels. Then, in Step S64, the image characteristic calculator 133 calculates the banding and the graininess with respect to the test patterns as a characteristic of image noise, based on the density distribution data transferred from the image density detector 132. The calculation results are sent to the process selector 134. The calculations of the banding data and the graininess data are performed in operations similar to those described with reference to FIG. 6.

Then, in Step S65, the process selector 134 performs the process selection to select an appropriate halftone process from among the plurality of halftone processes P1-P3, based on the banding data and the graininess data transferred from the image noise calculator 133. The selected halftone process is stored in the memory of the process selector 134. The halftone process selection is performed in an operation similar to that explained with reference to FIG. 10. Also, the calculation of the image noise calculator 133 and the selection of the process selector 134 are performed in operations similar to those described for the image forming apparatus 1.

A set of the banding data and the graininess data may be substituted by other physical characteristics of the test patterns having the largest values in average lightness in ranges different from each other. The halftone processes P1-P5 may be based on the dither with different number of lines, or the error diffusion, or a blue noise method. That is, any halftone process with any number of selections may be applied.

In addition, the above-mentioned image carrying member may includes a photosensitive member. As an alternative, if the image forming apparatus 100 has a structure including an intermediate transfer mechanism disposed between a photosensitive member for carrying a toner image and a transfer member for transferring the toner image onto a recording medium, the image carrying mechanism may include the intermediate image transfer member.

In addition, it may be possible to perform the measurement of the density distribution with respect to the toner image after the process of transferring the toner image onto a recording sheet, or fixing the toner image on the recording sheet after the transfer process.

Then, in Step S66, the image data input mechanism 118 inputs image data to the image data processing circuit 117 via the CPU 101. After that, in Step S67, the image processing circuit 117 performs the image area judgment to judge a text image area requiring an edge enhancement and a halftone image area requiring a noise reduction. Then, in Step S68, the image data processing circuit 117 references the memory of the process selector 134 and performs the halftone process selected in accordance with the input level, relative to the image area judged as a halftone image area. Also, an image area judged as a text image area is subjected to the edge enhancing process by the image processing circuit 117. After that, the image data is sent to the recording mechanism.

The edge enhancing process may use the Laplacian filter method or the unsharp mask (USM) method, or other common edge enhancing techniques.

Then, in Step S69, a toner image is formed according to the image data with the recording mechanism, the image carrying member, and the image developing mechanism. Then, the toner image is output through the image output mechanism 119.

In this way, the image forming apparatus 100 performs the halftone process selection based on the image noise of the banding and the granularity and the image area judgment relative to the input image data, and executes the edge enhancing process to the text image area and the selected appropriate halftone process to the halftone image area in the input image data. Thereby, the image forming apparatus 100 can reduce the plural types of image noise at the same time while maintaining a sharpness of the text image area.

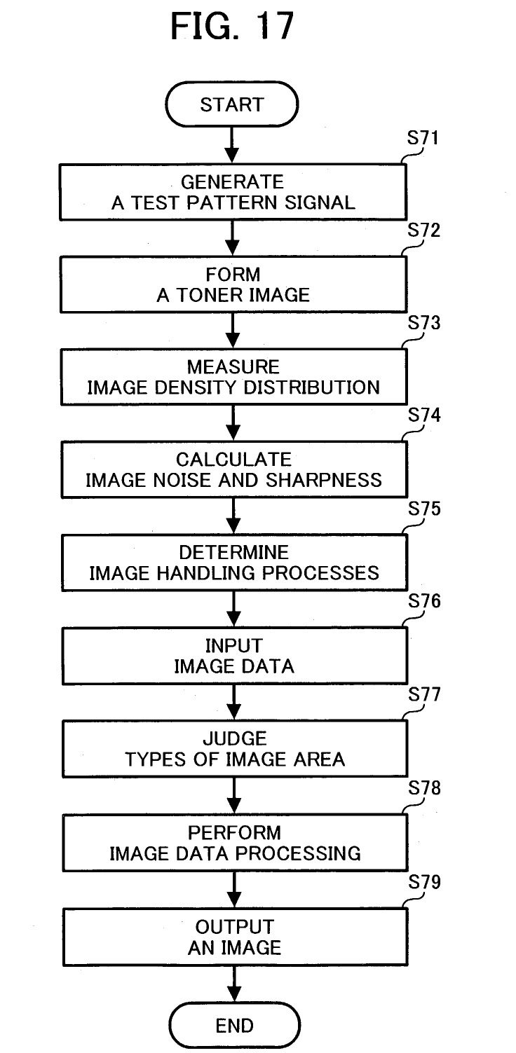

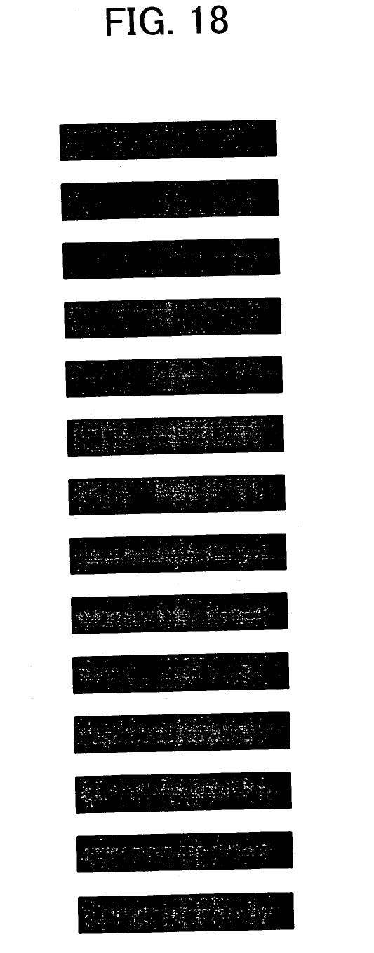

Next, another exemplary procedure of the image forming operation performed by the image forming apparatus 100 is explained with reference to FIG. 17. In addition to the halftone process selection, this exemplary procedure of FIG. 17 allows the image forming apparatus 100 to select an appropriate edge enhancement process. This selection is made in accordance with an image sharpness calculated based on the density distribution data with respect to an image formed using a test pattern shown in FIG. 18, and to perform the appropriate edge enhancement process relative to image data in a text image area of input image data. A test pattern used in this procedure includes, in addition to the test pattern for the halftone process selection, a ladder pattern of a black patch and a white patch, as shown in FIG. 18, having a frequency of 6 c/mm, for example, and is previously stored in the test pattern generator 131 of the process selecting mechanism 116.

In Step S71 of FIG. 17, the test pattern generator 131 of the process selecting mechanism 116 generates a test pattern signal and sends it to the recording mechanism. The test pattern signal represents the above-mentioned test pattern. Then, in Step S72, an image of the test pattern is formed through the electrophotographic procedure. That is, the recording mechanism forms a latent image on the image carrying member in accordance with a laser light beam modulated with the test pattern signal, and the image development mechanism develops a toner image of the test pattern.

Then, in Step S73, the image density detector 132 measures the density of the test pattern formed on the image carrying member, and outputs density distribution data of the test pattern to the image characteristic calculator 133. The density distribution data represents a distribution of the physical characteristic quantity with respect to the test pattern. Then, in Step S74, the image characteristic calculator 133 calculates an image sharpness as well as the image noise as the image characteristics with respect to the test pattern, based on the density distribution data transferred from the image density detector 132. The calculation results are sent to the process selector 134.

This discussion focuses on the edge enhancement process and omits explanation of the halftone process selection, for the sake of simplicity.

This procedure uses a modulation transfer function (MTF) for judging measurements of image sharness, as an example. The MTF is a ratio of a sine wave signal MTFᵢₙ representing an input image signal and a sine wave signal, MTFₒᵤₜ representing an output image signal, and is accordingly obtained with an equation MTF=MTFᵢₙ/MTFₒᵤₜ. In this embodiment, the density distribution data obtained from the ladder pattern of the test pattern shown in FIG. 18 has a rectangular wave signal, and therefore an MTFₒᵤₜ is represented by a wrectangular wave signal instead of a sine wave signal.

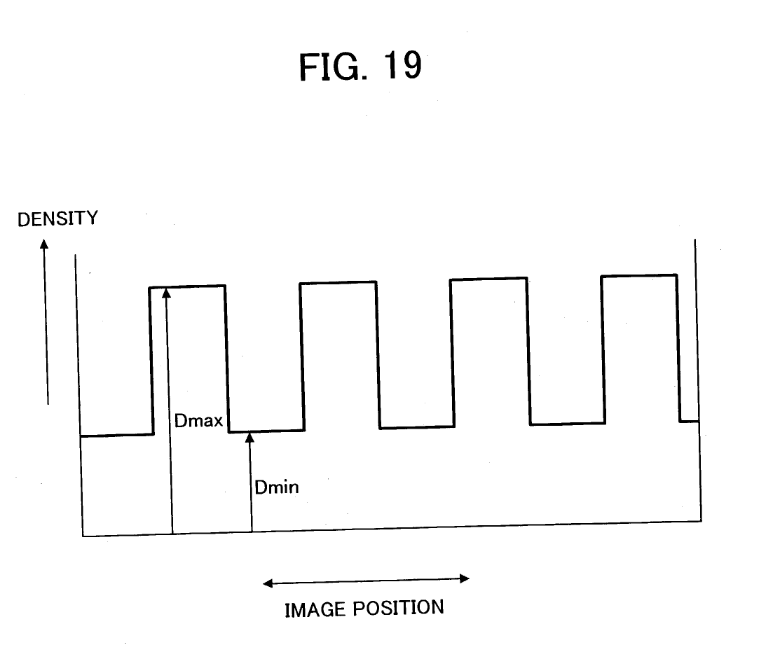

FIG. 19 shows an exemplary rectangular wave signal obtained based on the measurement results of the density distribution. MTFₒᵤₜ is expressed by an equation MTFₒᵤₜ=(Dₘₐₓ−Dₘᵢₙ)/(Dₘₐₓ+Dₘᵢₙ), wherein Dₘₐₓ and Dₘᵢₙ are the maximum and minimum values of the density detected. The resultant MTFₒᵤₜ value may be converted into a sine wave using a Coltman's correction.

In Step S75, the process selector 134 performs the halftone process selection and an edge enhancement process selection. In the edge enhancement process selection, the process selector 134 compares the MTFₒᵤₜ value transferred from the image density detector 132 with reference values, and a degree of edge enhancing is varied in accordance with the comparison result. The reference value is provided in association with the frequency of the ladder pattern. When the MTFₒᵤₜ value is found as smaller than the reference value, a process having a higher degree of edge enhancing is selected.

The edge enhancing process may use the unsharp mask (USM) method or the Laplacian filter method. The unsharp mask method performs a subtraction from original image data I₁(x, y) by image data <I₁(x, y) obtained by averaging or blurring image data <I₁(x, y)> to obtain an edge enhancing element [<I₁(x, y)−, I₁(x, y)]. Then, the edge enhancing element [<I₁(x, y)−, I₁(x, y)] is multiplied by a coefficient a, and the resultant data is then added to the original image data I₁(x, y) so that an edge enhanced image data I₂(x, y) is created. This calculation is expressed by an equation I₂(x, y)=I₁(x, y)+a[<I₁(x, y)−, I₁(x, y)], wherein a is a constant representing a degree of edge enhancing, and x and y represent the position of a focus pixel.

The Laplacian method uses a spatial filter equivalent to a secondary differentiation, and subtracts the original image data II(x, y) by a second derivative I₁(x, y), obtained from the original image data I₁(x, y), thereby producing the edge enhanced image data I₂(x, y). This operation is expressed by an equation I₂(x, y)=I₁(x, y)−Δ²I₁(x, y). Exemplary 3×3 matrices widely used by the Laplacian method are as follows.

| | | |
|---|---|---|
| 0 −1 0 | −1 −1 −1 | 1 −2 1 |
| −1 5 −1 | −1 9 −1 | −2 5 −2 |
| 0 −1 0 | −1 −1 −1 | 1 −2 1 |

As understood from the above explanation, a degree of edge enhancing can be adjusted by varying the coefficient a in the unsharp mask method and the filter matrix in the Laplacian method.

In this way, the process selector 134 changes a degree of edge enhancing in accordance with the evaluation with respect to the MTFₒᵤₜ value, and stores the resultant information in the memory thereof, in Step S65. At the same time, the process selector 134 selects an appropriate halftone process.

The image carrying member may include a photosensitive member. As an alternative, if the image forming apparatus 100 has a structure including an intermediate transfer mechanism disposed between a photosensitive member for carrying a toner image and a transfer member for transferring the toner image onto a recording medium, the image carrying mechanism may include the intermediate image transfer member.

As for the time of measuring the density distribution with respect to the test patches, it may also be possible to measure the density distribution of the toner image after the process of transferring the toner image onto a recording sheet or fixing the toner image on the recording sheet after the transfer process.

Then, in Step S76, the image data input mechanism 118 inputs image data to the image data processing circuit 117 via the CPU 101. After that, in Step S77, the image processing circuit 117 performs the image area judgment to judge a text image area requiring an edge enhancement and a halftone image area requiring a noise reduction. Then, in Step S78, the image data processing circuit 117 references the memory of the process selector 134 and performs the selected appropriate edge enhancement process relative to an image area judged as a text image area in the input image data. At the same time, the appropriate halftone process is also performed relative to the halftone image area of the input image data. After that, the image data is sent to the recording mechanism.

Then, in Step S79, a toner image is formed according to the image data with the recording mechanism, the image carrying member, and the image developing mechanism. Then, the toner image is output through the image output mechanism.

In this way, the image forming apparatus 100 performs the image area judgment and performs the appropriate edge enhancing process to the text image area while performing the appropriate halftone process. Thereby, the image forming apparatus 100 can reduce plural types of image noise from an image area of an input image while maintaining a sharpness in the text image area of the input image.

This invention may be conveniently implemented using a conventional general purpose digital computer programmed according to the teaching of the present specification, as will be apparent to those skilled in the computer art. Appropriate software coding can readily be prepared by skilled programmers based on the teachings of the present disclosure, as will be apparent to those skilled in the software art. The present invention may also be implemented by the preparation of application specific integrated circuits or by interconnecting an appropriate network of conventional component circuits, as will be readily apparent to those skilled in the art.

Numerous additional modifications and variations are possible in light of the above teachings. It is therefore to be understood that within the scope of the appended claims, the disclosure of this patent specification may be practiced otherwise than as specifically described herein.

This patent specification is based on Japanese patent application, No. JPAP2002-008610 filed on Jan. 17, 2002 in the Japanese Patent Office, the entire contents of which are hereby incorporated by reference herein.

What is claimed is:

1. An image forming apparatus, comprising:
an image carrying member configured to carry a toner image through an electrophotographic process;
a test pattern generator configured to generate a predetermined test pattern on the image carrying member;
a physical quantity measuring mechanism configured to measure a physical quantity distribution with respect to the predetermined test pattern; and
an image noise characteristic detector configured to detect plural types of image noise in the predetermined test pattern based on the physical quantity distribution with respect to the predetermined test pattern.

2. The image forming apparatus as defined in claim 1, wherein the plural types of image noise include a sub-scanning banding and a main-scanning banding.

3. The image forming apparatus as defined in claim 1, wherein the plural types of image noise include a banding and a graininess.

4. The image forming apparatus as defined in claim 1, wherein the predetermined test pattern includes a plurality of halftone images different from each other,
said image forming apparatus further comprising:
a process selector configured to select a halftone process based on the plural types of image noise detected from the predetermined test pattern by the image noise characteristic detector.

5. The image forming apparatus as defined in claim 1, wherein the predetermined test pattern includes a plurality of test pattern images having different halftone levels in response to a plurality of input levels, each of the test pattern images including a plurality of halftone images different from each other,
said image forming apparatus further comprising:
a process selector configured to select a halftone process based on the plural types of image noise detected from the predetermined test pattern by the image noise characteristic detector.

6. An image forming apparatus, comprising:
an image carrying member configured to carry a toner image through an electrophotographic process;
a test pattern generator configured to generate a predetermined test pattern on the image carrying member;
a physical quantity measuring mechanism configured to measure a physical quantity distribution with respect to the predetermined test pattern;
an image characteristic calculator configured to calculate image characteristics based on the physical quantity distribution measured by the physical quantity measuring mechanism;
an image area judging mechanism configured to judge image areas of original image data; and
a process selector configured to select an appropriate image processing operation to be performed relative to the original image data in accordance with the image characteristics calculated by the image characteristic calculator and a result of judgment performed by the image area judging mechanism.

7. The image forming apparatus as defined in claim 6, wherein the image characteristics calculated by the image characteristic calculator include plural types of image noise with respect to the predetermined test pattern.

8. The image forming apparatus as defined in claim 7, wherein the appropriate image processing operation includes a plurality of halftone processes different from each other.

9. The image forming apparatus as defined in claim 8, wherein the image area judging mechanism judges a text image area and a halftone image area in input image data.

10. The image forming apparatus as defined in claim 9, wherein the predetermined test pattern includes a plurality of halftone images different from each other, the process selector selects an appropriate halftone process from among the plurality of halftone processes based on the image characteristics calculated by the image characteristic calculator with respect to the predetermined test pattern and performs the selected appropriate halftone process relative to an image area of the original image data judged as a halftone image area by the image area judging mechanism and an edge enhancing process to an image area of the original image data judged as a text image area by the image area judging mechanism.

11. The image forming apparatus as defined in claim 9,
wherein the predetermined test pattern includes a plurality of test pattern images having different halftone levels in response to a plurality of input levels, the process selector selects an appropriate halftone process from among the plurality of halftone processes based on the image characteristics calculated by the image characteristic calculator with respect to the predetermined test pattern and performs the selected appropriate halftone process relative to an image area of the original image data judged as a halftone image area by the image area judging mechanism and an edge enhancing process to an image area of the original image data judged as a text image area by the image area judging mechanism.

12. The image forming apparatus as defined in claim 7,
wherein the image characteristics calculated by the image characteristic calculator include an image sharpness with respect to the predetermined test pattern, and the process selector selects an appropriate edge enhancing process based on the image sharpness calculated by the image characteristic calculator with respect to the predetermined test pattern so as to perform the appropriate edge enhancing process to an image area of the original image data judged as a text image area by the image area judging mechanism.

13. An image forming apparatus, comprising:
image carrying means for carrying a toner image through an electrophotographic process;
test pattern generating means for generating a predetermined test pattern on the image carrying means;
physical quantity measuring means for measuring a physical quantity distribution with respect to the predetermined test pattern; and
image noise characteristic detecting means for detecting plural types of image noise in the predetermined test pattern based on the physical quantity distribution with respect to the predetermined test pattern.

14. The image forming apparatus as defined in claim 13, wherein the plural types of image noise include a sub-scanning banding and a main-scanning banding.

15. The image forming apparatus as defined in claim 13, wherein the plural types of image noise include a banding and a graininess.

16. The image forming apparatus as defined in claim 13, wherein the predetermined test pattern includes a plurality of halftone images different from each other, said image forming apparatus further comprising:
process selecting means for selecting a halftone process based on the plural types of image noise detected from the predetermined test pattern by the image noise characteristic detecting means.

17. The image forming apparatus as defined in claim 13, wherein the predetermined test pattern includes a plurality of test pattern images having different halftone levels in response to a plurality of input levels, each of the test pattern images including a plurality of halftone images different from each other, said image forming apparatus further comprising:
process selecting means for selecting a halftone process based on the plural types of image noise detected from the predetermined test pattern by the image noise characteristic detecting means.

18. An image forming apparatus, comprising:
image carrying means for carrying a toner image through an electrophotographic process;
test pattern generating means for generating a predetermined test pattern on the image carrying means;
physical quantity measuring means for measuring a physical quantity distribution with respect to the predetermined test pattern;
image characteristic calculating means for calculating image characteristics based on the physical quantity distribution measured by the physical quantity measuring means;
image area judging means for judging image areas of original image data; and
process selecting means for selecting an appropriate image processing operation to be performed relative to the original image data in accordance with the image characteristics calculated by the image characteristic calculating means and a result of judgment performed by the image area judging means.

19. The image forming apparatus as defined in claim 18, wherein the image characteristics calculated by the image characteristic calculating means includes plural types of image noise with respect to the predetermined test pattern.

20. The image forming apparatus as defined in claim 19, wherein the appropriate image processing operation includes a plurality of halftone processes different from each other.

21. The image forming apparatus as defined in claim 20, wherein the image area judging means judges a text image area and a halftone image area in input image data.

22. The image forming apparatus as defined in claim 21, wherein the predetermined test pattern includes a plurality of halftone images different from each other, the process selecting means selects an appropriate halftone process from among the plurality of halftone processes based on the image characteristics calculated by the image characteristic calculating means with respect to the predetermined test pattern and performs the selected appropriate halftone process relative to an image area of the original image data judged as a halftone image area by the image area judging means and an edge enhancing process to an image area of the original image data judged as a text image area by the image area judging means.

23. The image forming apparatus as defined in claim 21, wherein the predetermined test pattern includes a plurality of test pattern images having different halftone levels in response to a plurality of input levels, the process selecting means selects an appropriate halftone process from among the plurality of halftone processes based on the image characteristics calculated by the image characteristic calculating means with respect to the predetermined test pattern and performs the selected appropriate halftone process relative to an image area of the original image data judged as a halftone image area by the image area judging means and an edge enhancing process to an image area of the original image data judged as a text image area by the image area judging means.

24. The image forming apparatus as defined in claim 21,
wherein the image characteristics calculated by the image characteristic calculating means include an image sharpness with respect to the predetermined test pattern, and the process selecting means selects an appropriate edge enhancing process based on the image sharpness calculated by the image characteristic calculating means with respect to the predetermined test pattern so as to perform the appropriate edge enhancing process to an image area of the original image data judged as a text image area by the image area judging means.

25. An image forming method, comprising:
generating a predetermined test pattern through an electrophotographic process;
measuring a physical quantity distribution with respect to the predetermined test pattern; and
detecting plural types of image noise in the predetermined test pattern based on the physical quantity distribution with respect to the predetermined test pattern.

26. The image forming method as defined in claim 25, wherein the plural types of image noise include a sub-scanning banding and a main-scanning banding.

27. The image forming method as defined in claim 25, wherein the plural types of image noise include a banding and a graininess.

28. The image forming method as defined in claim 25, wherein the predetermined test pattern includes a plurality of halftone images different from each other,
said image forming method further comprising:
selecting a halftone process based on the plural types of image noise detected from the predetermined test pattern by the detecting.

29. The image forming method as defined in claim 25, wherein the predetermined test pattern includes a plurality of test pattern images having different halftone levels in response to a plurality of input levels, each of the test pattern images including a plurality of halftone images different from each other,
said image forming method further comprising:
selecting a halftone process based on the plural types of image noise detected from the predetermined test pattern by the detecting.

30. An image forming method, comprising:
generating a predetermined test pattern through an electrophotographic process;
measuring a physical quantity distribution with respect to the predetermined test pattern;
calculating image characteristics based on the physical quantity distribution measured by the physical quantity measuring;
judging image areas of original image data; and
selecting an appropriate image processing operation to be performed relative to the original image data in accordance with the image characteristics calculated by the calculating and a result of judgment performed by the judging.

31. The image forming method as defined in claim 30, wherein the image characteristics calculated by the calculating include plural types of image noise with respect to the predetermined test pattern.

32. The image forming method as defined in claim 31, wherein the appropriate image processing operation includes a plurality of halftone processes different from each other.

33. The image forming method as defined in claim 32, wherein the judging judges a text image area and a halftone image area in input image data.

34. The image forming method as defined in claim 33,
wherein the predetermined test pattern includes a plurality of halftone images different from each other, the selecting selects an appropriate halftone process from among the plurality of halftone processes based on the image characteristics calculated by the calculating with respect to the predetermined test pattern and performs the selected appropriate halftone process relative to an image area of the original image data judged as a halftone image area by the judging and an edge enhancing process to an image area of the original image data judged as a text image area by the judging.

35. The image forming method as defined in claim 33,
wherein the predetermined test pattern includes a plurality of test pattern images having different halftone levels in response to a plurality of input levels, the selecting selects an appropriate halftone process from among the plurality of halftone processes based on the image characteristics calculated by the calculating with respect to the predetermined test pattern and performs the selected appropriate halftone process relative to an image area of the original image data judged as a halftone image area by the judging and an edge enhancing process to an image area of the original image datajudged as a text image area by the judging.

36. The image forming method as defined in claim 33,
wherein the image characteristics calculated by the calculating step include an image sharpness with respect to the predetermined test pattern, and the selecting selects an appropriate edge enhancing process based on the image sharpness calculated by the calculating with respect to the predetermined test pattern so as to perform the appropriate edge enhancing process to an image area of the original image data judged as a text image area by the judging.
